(19) United States
(12) Patent Application Publication
(10) Pub. No.: US 2007/0278292 A1
(43) Pub. Date: Dec. 6, 2007

(54) RETAIL CASH PRODUCT

(76) Inventor: Sean MacGuire, Beaconsfield (CA)

Correspondence Address: SCHWARTZ COOPER CHARTERED;IP DEPARTMENT, 180 NORTH LASALLE STREET, SUITE 2700, CHICAGO, IL, 60601, US

(21) Appl. No.: 11/752,286

(22) Filed: May 22, 2007

Related U.S. Application Data
(60) Provisional application No. 60/747,819, filed on May 22, 2006.
(60) Provisional application No. 60/803,098, filed on May 24, 2006.

(51) Int. Cl. G06K 5/00

(52) U.S. Cl. 235/380

(57) ABSTRACT

The invention discloses a retail cash product available in multiple denominations, encoded with Point of Sale information allowing it to be purchased like any other retail product, which becomes a usable debit card once activated by the consumer. The ability for consumers to use gift cards, gift certificates, or credit cards to purchase this retail cash product provides them with the ability to obtain cash. Unlike reloadable debit cards, the retailer does not need special equipment, training, or processing at checkout; and the Cash Product Company even provides the funds to load onto the card, which the retailer repays in due course.

### CROSS-REFERENCE TO RELATED APPLICATIONS

This application is a nonprovisional application claiming priority to U.S. Provisional Patent Application No. 60/747,819, filed May 22, 2006 and U.S. Provisional Patent Application No. 60/803,098, filed May 24, 2006.

### FEDERALLY SPONSORED RESEARCH OR DEVELOPMENT

None.

1. Technical Field

The present invention relates generally to the field of banking and more specifically to a system and method for creating and using a retail cash product.

2. Background of the Invention

With the introduction of financial tools like debit cards, smart cards and other “stored value” cards, consumers have more ways to access funds than ever before. Likewise, the number of systems which can use these devices, like ATMs, debit terminals, telephone IVR systems, and internet-based systems has likewise multiplied in number. One of the effects of this increase in electronic access cards and systems is a corresponding increase in electronic funds transactions.

Likewise the recent proliferation of gift cards—essentially electronic gift certificates—has made gift giving much easier for consumers. Merchants like these cards as well for several reasons including that they do not always get completely used up, consumers spend more when using them, and the associated revenues are generally reported after the holidays, i.e. in January, instead of before the holidays in December.

However, as has always been the case, the recipient of a gift card may prefer to get cash instead. This would be possible if there existed a “cash product” the recipient could purchase from the store in question, using said gift card.

If a debit card could be purchased like any other product at a store, without the retailer needing special equipment and training, it would allow many more stores to provide these debit cards to their customers, especially if the merchant did not need to provide the cash themselves. Users would simply pick up the “cash product”, pay for it at the register like any other purchase, activate it, and use it at an Automated Teller Machine (ATM) to get cash.

In addition, by allowing a retail outlet to sell this “cash product”, a completely new type of transaction would be created—the ability to convert gift cards to cash by using a gift card to purchase this “cash product”. Likewise, users could use their store credit cards to purchase this “cash product” as well, essentially allowing the user to get cash from a store credit card—a feature generally not available.

Risafi in U.S. Pat. No. 6,473,500 discloses what is now recognized as a reloadable debit card. Benkert in U.S. Pat. No. 6,796,497 discloses cards with attached subsidiary cards which can control how the money on the card is allocated and spent. Martin, Jr. in U.S. Pat. No. 6,304,860 discloses a system to use the ATM network to facilitate automated debt payments. The website http://giftcards.com likewise shows a combination gift card/ATM card which can be purchased and activated online.

Although the above individually addresses certain elements of our invention, they do not cover the elements of using gift cards to get cash by allowing a debit card to be purchased at a retail outlet like any other product and subsequently be activated and used at an ATM machine, nor does it cover the Cash Product Company providing the funds, instead of the merchant, and being repaid at a later date.

Therefore a need has arisen for a retail cash product—debit cards which can be purchased at a retail outlet like any other product, and subsequently activated, without the need for the merchant to handle the funding or have specialized debit card equipment and training. This allows consumers to use gift cards and gift certificates to get cash, and get cash from credit cards which do not normally support this feature.

### SUMMARY OF THE INVENTION

The present invention creates a “retail cash product”, a product which may be purchased by a consumer from a retail outlet and subsequently used to obtain cash. This purpose of such an invention is straightforward—it permits consumers to obtain cash easily, usually by using credit cards, gift cards, or gift certificates for the purchase.

An illustrative embodiment consists of a financial card upon which is printed a denomination whose magnetic stripe is pre-encoded with a unique identifier, also bearing an identifier such as a barcode or RFID tag to allow automatic identification of the item at checkout. Once purchased, the consumer activates this product by phone at which point it becomes a valid debit card containing the amount of funds printed on the card, which may be used to withdraw cash from an ATM machine, or purchase products from retailers who support such purchases.

The present invention further relates to a certain classes of financial cards; cards which permit the user only to spend the amount of money which has been previously loaded onto the card. Usually these financial cards are attached to an account held at the financial institution which sponsors the card. “Loading” refers to the process of remotely depositing funds into the account associated with the card, traditionally via a local merchant.

For the sake of simplicity these cards will now be referred to as “debit cards”, although any financial instrument, smart card, RFID or other wireless or electronic system, purse, or wallet could be used provided it meets the conditions of the user being able only to spend or withdraw what has been deposited beforehand, being loadable, generally remotely, i.e. funds may be loaded onto the card without having to be physically present at the institution issuing the card, and being attached to an account at the issuing institution.

However, a merchant loading debit cards generally needs to be specially equipped. This equipment generally consists of a terminal connected to the debit card issuer as well as a device which is capable of writing information onto a debit card as well as a PIN terminal allowing the user to select his Personal Identification Number for use in subsequent transactions. In addition, the merchant requires specific training in the use of this equipment for issuing these cards, and needs to have established an electronic account associated with the Debit Card Provider, and is responsible for having the funds available to be loaded from this account onto any debit cards they sell.

The present invention enhances the current system in a number of ways. First, by providing a debit card with POS information for the retail cashier processes this sale like any other product. No special training required, just scan the item.

Another enhancement involves the relationship between the debit card provider and the merchant. Because this is an actual product, it is processed in a manner similar to any other product the merchant carries. The merchant orders and receives an inventory of cards, and knows how much each card will cost them once activated. More importantly, they control the profit margin on the product, in other words they can decide how much to charge for each card, by denomination, and they can even put the product “on sale”. Finally, like any other retail relationship, they negotiate terms and conditions with the Cash Product Company such as payment “Net 30 days”.

This illustrates another important enhancement—currently, if a store loads debit cards for their customers, they accept the funds to load onto the card from the consumer, plus a service charge, contact the debit card company who takes the funds to be loaded onto the card from the merchant's account associated with the debit card company, and places these funds onto the debit card being purchased, all in near real time. By treating these debit cards as a “cash product”, like any other product, the Cash Product Company now gets paid under whatever contractual terms they negotiate with the merchant. This effectively gives the merchant an interest-free use of the loaded funds until they repay the Cash Product Company.

Finally, having the consumer activate the debit card directly with the Cash Product Company relieves the retailers of the burden of training all their staff in the handling of debit cards, as well eliminating the need for the special equipment at each cash register to perform the loading, and the time required to perform this procedure.

### BRIEF DESCRIPTION OF THE DRAWINGS

The features of the invention will become more apparent in the following detailed description in which reference is made to the appended drawings wherein:

FIG. 1 is a schematic representation showing the relationship between the Cash Product Company and the retailer.

FIG. 2 is a schematic representation showing the retail display for the cash product.

FIG. 3 is a schematic representation of the back of the cash product card.

FIG. 4 is a flowchart showing a purchase of the cash product.

FIG. 5 is a flowchart showing the activation of a purchased cash product.

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

The transactions described herein may be performed in different ways, in person, or remotely using telephonic or electronic means. However for this illustrative example, we will have a consumer purchase a cash product from a retail outlet in person, and activate the cash product by telephone using an IVR system.

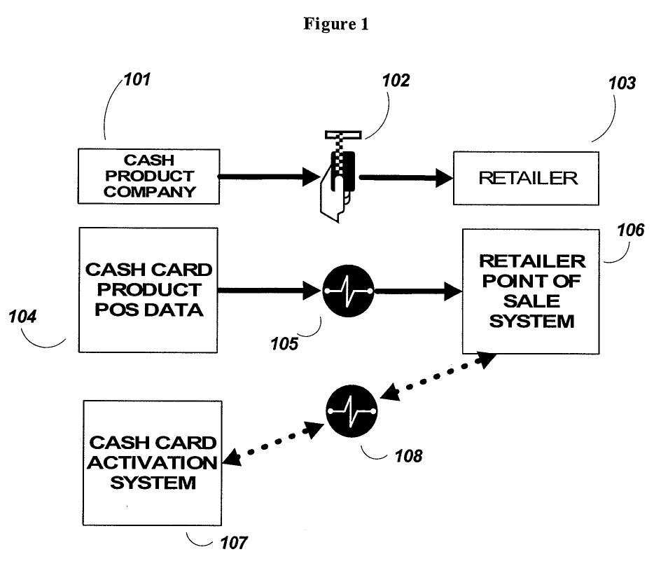

Referring now to FIG. 1, we have a Cash Product Company 101, which provides card inventory 102 to a retailer 103 based on a contractual agreement which include the terms and conditions under which the product is sold and terms of payment.

In addition, the Cash Product Company 101 provides product data possibly including activation codes 104 via an electronic network 105 to the retailer's point of sale system 106. Note that the connection at 105 need not necessarily be electronic; the product information could be provided on CDROM or other media. In addition, activation codes may be optional in the case where the retailer's POS system 106 transmits card purchase information to the Card Product Company's Cash Card Activation System 107 via an optional network 108 in near real time.

Note that the activation codes could be generated by an algorithm or other method, or retrieved in real time from the Cash Product Company network or elsewhere by alternate means; however we prefer the use of randomly generated activation codes fetched from the Activation System in near real time during the purchase of the Cash Product, which are then printed on the consumer's receipt. This provides an important method of reducing potential fraudulent use of the Cash Product, either from theft of the activation codes or algorithm from the Activation System or retail POS system or from attempts to clone, activate and use cards prior to them being activated and used by the consumer.

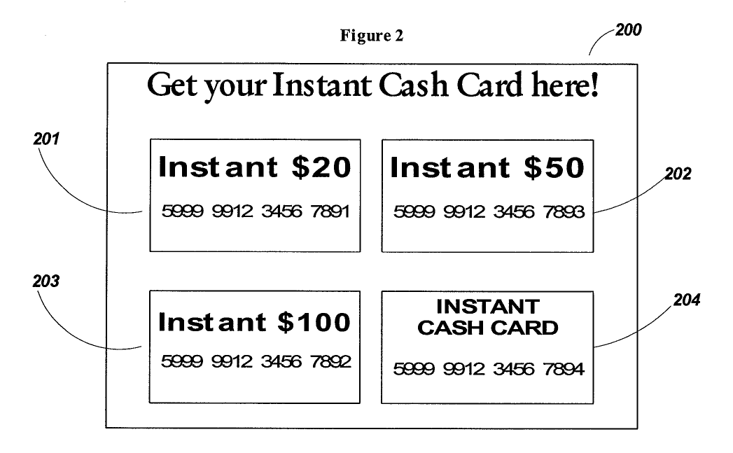

Referring now to FIG. 2, we have a retail display 200, containing our cash product in a variety of denominations, for instance 20 dollars at 201, 50 dollars at 202, 100 dollars at 203, and a custom amount determined by the consumer at checkout 204. The denominations shown are illustrative only, as other denominations are possible, and the cards themselves may likewise be packaged on blister cards, or in other decorative packaging, and branded with the retailer's logo if desired; in fact, they do not even have to be cards, provided the devices can be later activated and used to get funds.

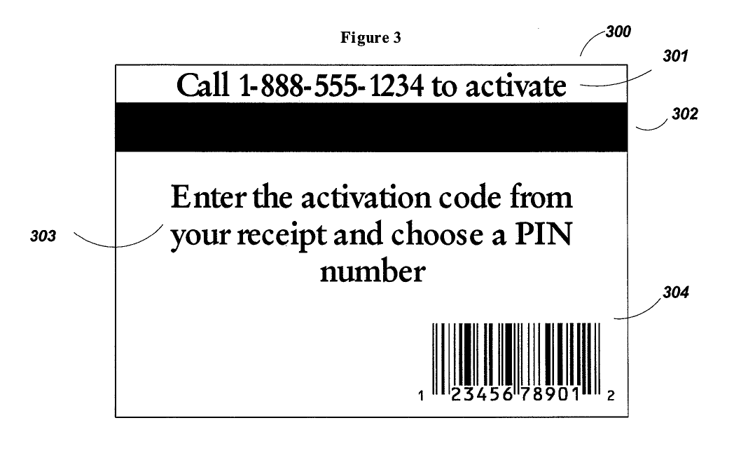

Referring now to FIG. 3, this shows the back of the cash product card 300 which contains a phone number 301 to call, a magnetic stripe 302 allowing the card information to be read by machine, activation instructions 303 for the consumer, as well as a barcode 304 to be scanned at the cash register. Note that the barcode 304 could be any means which allows the POS system to electronically identify the item. Likewise the magnetic stripe 302 could be anything which allows the information on the card 300 to be read by machine. In fact, there is no reason that in the future these elements might not be combined into a single unit, such as a RFID tag or smart chip.

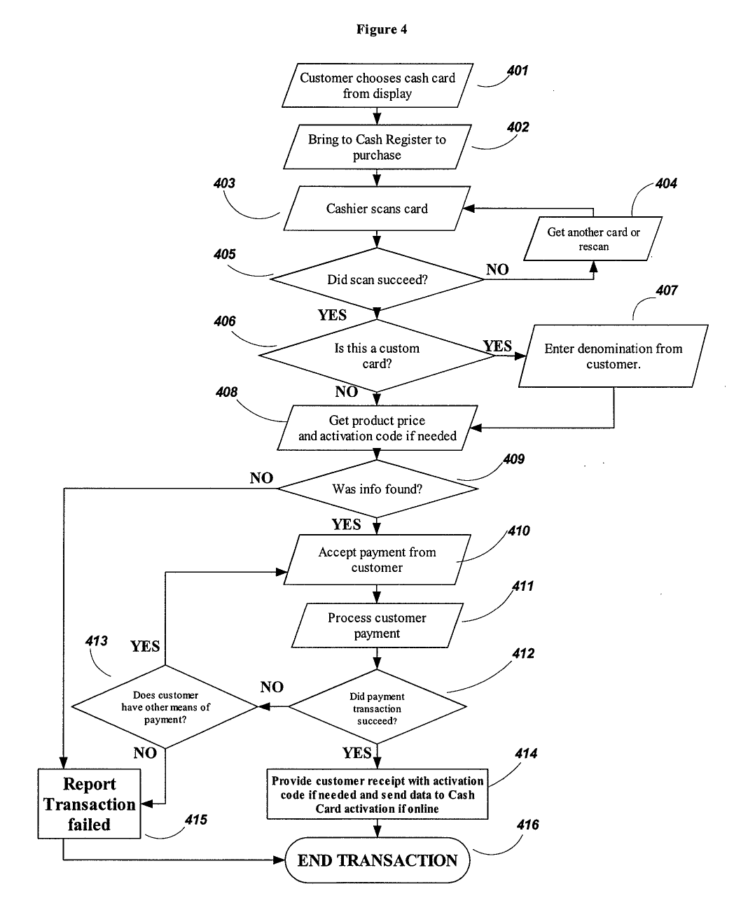

Referring now to FIG. 4, the consumer selects the Cash Product they wish to purchase at 401 from the retail display 200, and brings it to the cash register at 402. The cashier scans the barcode 304 on the product to capture at 403 the unique card identifier. We then check at 405 to see if the scan succeeded. If the scan failed, the scan is retried, or another card selected at 404, otherwise we check at 406 to see if this is a custom card. If so, the cashier requests the denomination for card from the consumer, and enters it in the POS system; however in order to sell these custom cards, the retailer must be connected to the Cash Card Activation system 107 by network 108, otherwise it is impossible for the Cash Product Company to know how much money to load onto the card.

Note that because Point of Sale systems and the processes used to sell products vary between retailers, the electronic information, and card presentation associated with the Card Product may be modified to meet retailers' requirements. Likewise, since processes also differ, additional steps may be needed. For example, during the checkout process, the Cash Product card may have to be swiped to obtain the account number, should this be necessary.

The POS system now retrieves the item information at 408. It should find, at least, the price to charge for the product, as well as the activation code 104 if required. If the all required data is not found the transaction fails at 415, and ends at 416 such that the product cannot be purchased.

Next, the consumer is asked at 410 to provide payment for the purchase, which is processed at 411. We then check at 412 to see if the payment succeeded or failed. If the payment failed, the user is to provide other means of payment at 413. If they can, the process is repeated at 410, otherwise the product cannot be purchased, the transaction fails at 415, and ends at 416. Note that the retailer is free to establish his/her own criteria for regulating the sale of this Cash Product, including establishing controls on how much Cash Product may be purchased in any given time period, by any or particular customers, using whatever payment means. For example, a retailer may not permit the Cash Product to be purchased using his/her store credit card, or may limit the purchase to a $100 cash product every 30 days.

Once the payment has been successfully made, the retailer provides the consumer with a copy of the receipt for the sale upon which is printed the activation code (if necessary), and sends the card purchase information at 414 to the Card Activation System 107 via the network 108 if they are online, and the transaction ends 416.

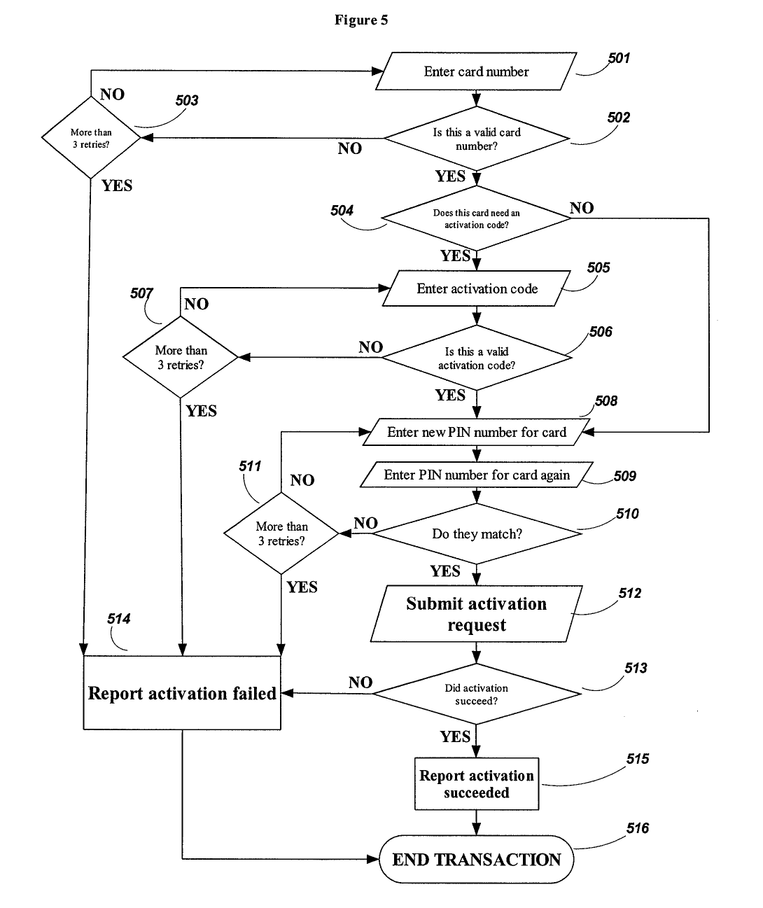

Now referring to FIG. 5, there is shown the process for activating the Cash Product. The consumer calls the number 301 on the back of the card 300, and follows the instructions 303. First, the user is prompted at 501 to enter the card number, located on the front of the card 200. The card number is then checked at 502 to see if it is valid. If not, we check at 503 to see if the user has tried to enter this number more than 3 times, and if so, the activation fails at 514 and the transaction ends at 516; otherwise we try again at 501. If the number is valid, we check at 504 to see if this card requires the user to enter an activation code; if so the user is prompted at 505 to enter his/her activation code which is printed on their receipt at 414. The activation code is then checked for validity at 506. If the activation code is not valid, we check at 507 to see if the user has tried to enter this number more than 3 times, and if so, the activation fails at 514 and the transaction ends at 516; otherwise we try again at 505.

Now that we have a valid card number and activation code, the user is prompted at 508 to select their PIN number. To make sure the user has entered the PIN number correctly, he/she is asked to enter his/her PIN number again at 509. The PIN numbers are then checked at 510 to see if they are the same. If they are not, we check at 511 to see if the user has tried to enter this number more than 3 times, and if so, the activation fails at 514 and the transaction ends at 516; otherwise we try again at 508.

If the PIN numbers match, we then submit an activation request at 512. The activation request is where the Cash Product becomes an active debit card, and funds are loaded into the account associated with the card, protected by the selected PIN number. We now check at 513 to see if the activation request succeeded. If the activation request fails, it is reported at 514 and the transaction ends at 516. Otherwise we report at 515 that the activation succeeded, the card is ready to use, and the transaction ends at 516.

Note that this procedure could be done by internet, IVR, or other method, that instructions may or may not be printed on the card, or included as an insert, that the number of retries noted here are typical but may be changed, and that other authentication methods, biometric or otherwise, could be used in place of the PIN number.

Although the invention has been described with reference to certain specific embodiments, various modifications thereof will be apparent to those skilled in the art without departing from the spirit and scope of the invention. The entire disclosures of all references recited above are incorporated herein by reference.

What I claim is:

1. A card comprising:
a set monetary denomination associated with the card and stored electronically on the card;
a first identifier associated with the card and stored on the card to identify both the card and the set monetary denomination and stored in such a manner as to be read by machine that distributes money, such as an ATM machine; and,
at least one second identifier stored on the card permitting automatic identification of the card and the set monetary denomination at a checkout system wherein the card is purchased.

2. The card of claim 1 wherein the first identifier is a magnetic strip pre-encoded on the card and the second identifier is selected from the group comprising a barcode and a RFID tag.

3. The card of claim 1 wherein the card further includes an activation code stored on the card for activating the card at the checkout system.

4. A method of using a card comprising the steps of:
providing a card having:
a set monetary denomination associated with the card and stored electronically on the card,
a first identifier associated with the card and stored on the card to identify both the card and the set monetary denomination, and
at least one second identifier stored on the card permitting automatic identification of the card and the set monetary denomination at a checkout system; and,
activating the card by one of the checkout system at the point of purchase or through a third party by having the third party verify the first identifier.
